(19) United States
(12) Patent Application Publication
(10) Pub. No.: US 2021/0031352 A1
(43) Pub. Date: Feb. 4, 2021

(54) NOVEL CARTRIDGE MAINTENANCE SYSTEM FOR A MIXING TAP

(71) Applicant: Chris Spirou, Holiday, FL (US)

(72) Inventor: Chris Spirou, Holiday, FL (US)

(21) Appl. No.: 16/983,925

(22) Filed: Aug. 3, 2020

Related U.S. Application Data
(60) Provisional application No. 62/881,816, filed on Aug. 1, 2019.

(51) Int. Cl. B25D 1/16

(52) U.S. Cl. CPC B25D 1/16; B25D 2250/371

(57) ABSTRACT

A cartridge maintenance system for freeing a seized cartridge in a tap features a water tap having a cartridge located therein. The system features a linear, spring-biased slide hammer with a linear shaft. A gripping handle is located on a shaft second end. A slide weight features a channel located there through. A spring is located on the shaft first end between the gripping handle and the slide weight. The slide weight is biased in a static position at a linear shaft first end. A threaded adapter is located on the linear shaft first end. The slide hammer is screwed into a threaded aperture of the cartridge via the mated threaded adapter until snug. The slide weight is pulled away from the linear shaft first end, then released to create an impact The impact is transferred to the cartridge for freeing seized parts in the cartridge.

### CROSS-REFERENCES TO RELATED APPLICATIONS

This application is a non-provisional and claims benefit of U.S. Provisional Application No. 62/881,816 filed Aug. 1, 2019, the specifications of which are incorporated herein in their entirety by reference.

### FIELD OF THE INVENTION

The present invention relates to plumbing tools or more specifically, plumbing tools pertaining to taps, spigots, or faucets.

### BACKGROUND OF THE INVENTION

Mixing taps for controlling a mixture of hot and cold water flow into a combined stream at a desired temperature are widely used. Sometimes, however, if a tap is not used often, it can become seized or stuck. In the event that a mixing tap becomes seized, the most common way to repair the tap is removal. This can be time-consuming. The present invention features a cartridge, maintenance system for freeing a seized cartridge in a tap without removing the cartridge.

### SUMMARY OF THE INVENTION

The present invention features a cartridge maintenance system for freeing a seized cartridge in a tap. In some embodiments, the system comprises a water tap having a cartridge located therein.

In some embodiments, the system comprises a linear, spring-biased slide hammer with a linear shaft. In some embodiments, a gripping handle is located on a shaft second end. In some embodiments, a slide weight comprises a channel located therethrough. In some embodiments, the slide weight slides on a shaft through the channel. In some embodiments, a spring is located on a first end of the shaft between the gripping handle and the slide weight. In some embodiments, the slide weight is biased in a static position at, a first end of the linear shaft. In some embodiments, a threaded adapter is located on the first end of the linear shaft.

In some embodiments, the slide hammer is screwed into a threaded aperture of the cartridge via the mated threaded adapter until snug. In some embodiments the slide weight is pulled away from the linear, shaft first end, then released to create an impact. In some embodiments, the impact is transferred to the cartridge for freeing seized parts in the cartridge.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE DRAWINGS

FIG. 1 shows a perspective view of the slide hammer of the present invention.

FIG. 2 shows a side view of the slide hammer of the present invention.

FIG. 3 shows a cross-sectional view of the slide hammer of the present invention.

FIG. 4 shows a side view of the present invention in use.

FIG. 5-8 shows an alternative design of the present invention.

FIG. 9 shows a back end view of the handle.

### DESCRIPTION OF PREFERRED EMBODIMENTS

Following is a list of elements corresponding to a particular element referred to herein:

100 Cartridge maintenance system

112 Cartridge

113 Threaded aperture

120 Slide hammer

130 Shaft

131 Shaft first end

132 Shaft second end

135 Stop

140 Handle

150 Slide weigh

152 Channel

160 Spring

170 Threaded adapter

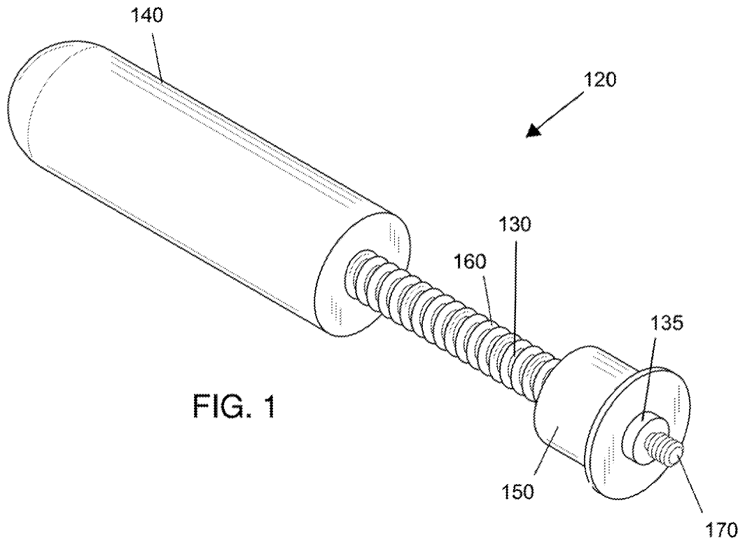

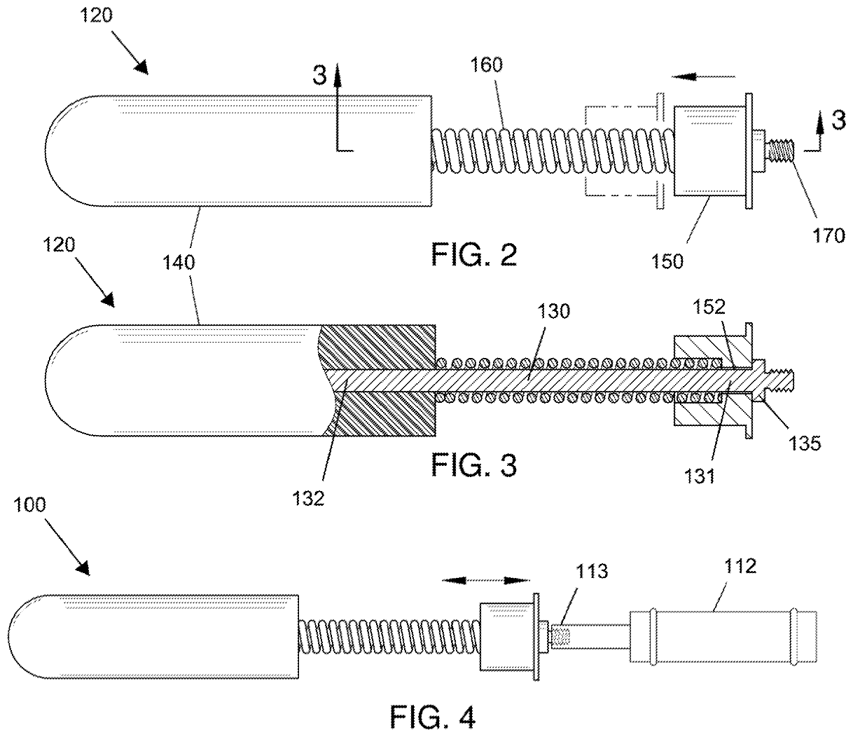

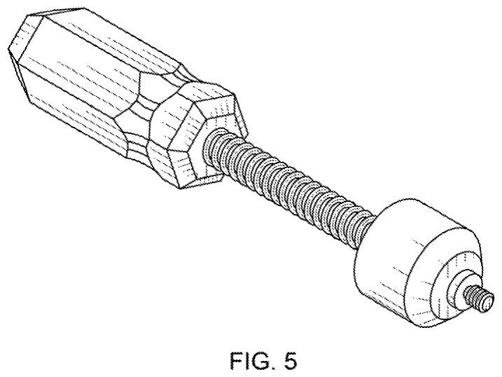

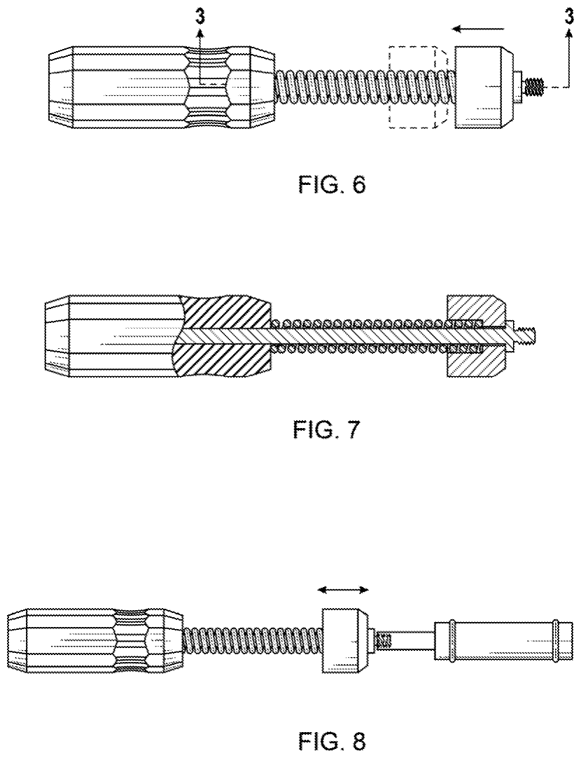

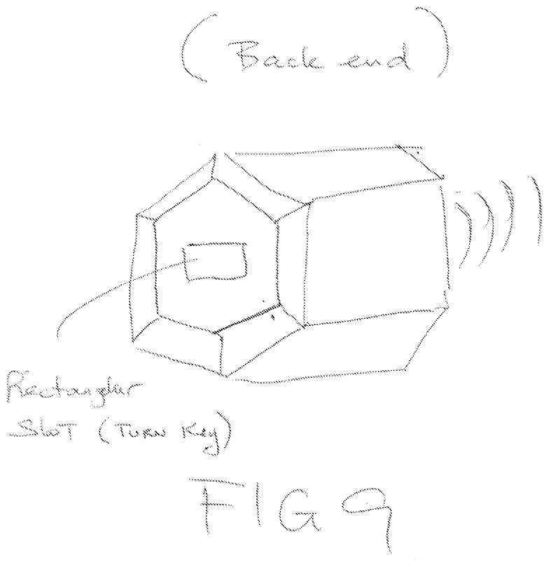

Referring now to FIG. 1-4, the present invention features a cartridge maintenance system (100) for freeing a seized cartridge in a tap. In some, embodiments, the system (100) comprises a water tap having a valve with a cartridge (112) located therein. In some embodiments, the cartridge, is a MOEN® Posi-Temp cartridge.

In some embodiments, the system (100) comprises a linear spring-biased slide hammer (120) comprising a linear shaft (130) having a shaft first end (131) and a shaft second end (132). In some embodiments, a gripping handle (140) is located on the shaft second end (132). In some embodiments, a stop (135) is located on the shaft first end (131). In some embodiments, the stop (135) is removable. In some embodiments, the stop (135) is not removable.

In some embodiments, a slide weight (150) comprises a channel (152) centrally located there through. In some embodiments, the slide weight (150) is slidably located on the linear shaft (130) through the channel (152) between the gripping handle (140) and the stop (135). In some embodiments, a spring (160) is located on the shaft (130) between the gripping handle (140) and the slide weight (150). In some embodiments, the slide weight (150) is biased in a static position at a linear shaft first end (131) against the stop (135). In some embodiments, a threaded adapter (170) is located on the linear shaft first end (131) next to the stop (135).

In some embodiments, the slide hammer (120) is rotatably screwed into a threaded aperture (113) on a top of the cartridge (112) via the mated threaded adapter (170) until snug. In some embodiments, the slide weight (150) is pulled away from the stop (135) toward the shaft second end (132), then released to create an impact upon colliding with the stop (135) via the loaded spring (160). In some embodiments, the impact is transferred to the, cartridge (112) for freeing seized parts in the cartridge (112) via the threaded adapter (170) interfacably connecting to the threaded aperture (113).

In some embodiments, the water tap is a mixing water tap. In some embodiments, a balancing spool is unseized from the cartridge.

In some, embodiments, the slide weight (150) weighs 1-4 ounces. In some embodiments, the slide weight (150) weighs 4-8 ounces. In some embodiments, the slide weight (150) weighs 8-16 ounces. In some embodiments, the slide weight (150) weighs 16 or more ounces.

The present invention features a linear spring-biased slide hammer (20) for use in a cartridge maintenance system (100). In some embodiments, the linear spring-biased slide hammer (120) may comprise a linear shaft (130) having a shaft first end (131) and a shaft second end (132), a gripping handle (140) disposed on the shaft second end (132), a stop (135) disposed on the shaft first end (131), and a channel (162) disposed between the gripping handle (140) and the stop (135). The linear spring-biased slide hammer (120) may further comprise a slide weight (150) slidably disposed on the linear shaft (130) through the channel (152). The slide weight (150) may be biased in a static position at the shaft first end (131) against the stop (135). The linear spring-biased slide hammer (120) may further comprise a spring (160) disposed on the shaft (130) between the gripping handle (140) and the slide weight (150), and a threaded adapter (170) disposed on the shaft first end (131) adjacent to the, stop (135). In some embodiments, the slide hammer (120) may be configured to be rotatably screwed into a threaded aperture (113) of a cartridge (112) of a valve of a water tap via the mated threaded adapter (170) until snug. In some embodiments, the slide weight (150) may be pulled away from the stop (135) toward the shaft second end (132), then released to create an impact upon colliding with the stop (135) via the loaded spring (160). In some embodiments, the linear spring-biased slide hammer (120) may be configured to transfer the impact to the cartridge (112) for freeing seized parts in the cartridge (112) via the threaded adapter (170) interfacably connecting to the threaded aperture (113). In some embodiments, the slide weight (150) weighs 1-4 ounces. In some embodiments, the slide weight (150) weighs 4-8 ounces. In some embodiments, the slide weight (150) weighs 8-16 ounces. In some embodiments, the slide weight (150) weighs 16 or more ounces.

The present invention features a method for freeing a seized cartridge in a tap. In some embodiments, the method may comprise providing a linear spring-biased slide hammer (120). The linear spring-biased slide hammer (120) may comprise, a linear shaft (130) having a shaft first end (131) and a shaft second end (132), a gripping handle (140) disposed on the shaft second end (132), a stop (135) disposed on the shaft first end (131), and a channel (152) disposed between the gripping handle (140) and the stop (135). The linear spring-biased slide hammer (120) may further comprise a slide weight (150) slidably disposed on the linear shaft (130) through the channel (152). The slide weight (150) may be biased in a static position at the shaft first end (131) against the stop (135). The linear spring-biased slide hammer (120) may further comprise a spring (160) disposed on the shaft (130) between the gripping handle (140) and the slide weight (150), and a threaded adapter (170) disposed on the shaft first end (131) adjacent to the stop (135). The method may further comprise rotatably screwing the slide hammer (120) into a threaded aperture (113) of a cartridge (112) of a valve of a water tap via the mated threaded adapter (170) until snug. The method may further comprise pulling the slide weight (150) away from the stop (135) toward the shaft second end (132), and releasing the slide weight (150) to create an impact upon colliding with the stop (135) via the loaded spring (160). In some embodiments, the linear spring-biased slide hammer (120) transfers the impact to the cartridge (112) to free seized parts in the cartridge (112) via the threaded adapter (170) interfacably connecting to the threaded aperture (113). In some embodiments, the water tap is a mixing water tap. In some embodiments, the slide weight (150) weighs 1-4 ounces. In some embodiments, the slide weight (150) weighs 4-8 ounces. In some embodiments, the slide weight (150) weighs 8-16 ounces. In some embodiments, the slide weight (150) weighs 16 or more ounces.

As used herein, the term “about” refers to plus or minus 10% of the referenced number.

The disclosures of the following U.S. Patents are incorporated in their entirety by reference herein: U.S. Pat. Nos. D 294,219; 7,987,571; 6,929,024; 5,915,741; 5,119,556; 5,054,179; 4,823,453; and 4,079,494.

Various modifications of the invention, in addition to those described herein, will be apparent to those skilled in the art from the foregoing description. Such modifications are also intended to fall within the scope of the appended claims. Each reference cited in the present application is incorporated herein by reference in its entirety.

Although there has been shown and described the preferred embodiment of, the present invention, it will be readily apparent to those skilled in the art that modifications may be made thereto which do not exceed the scope of the appended claims. Therefore, the scope of the invention is only to be limited by the following claims. Reference numbers recited in the claims are exemplary and for ease of review by the patent office only, and are not limiting in any way. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting of”, and as such the written description requirement for claiming one or more embodiments of the present invention using the phrase “consisting of” is met.

The reference numbers recited in the below claims are solely for ease of examination of this patent application, and are exemplary, and are not intended in any way to limit the scope of the claims to the particular features having the corresponding reference numbers in the drawings.

What is claimed is:

1. A cartridge maintenance system (100) for freeing a seized cartridge in a tap, wherein the system (100) comprises:
(a) a water tap having a valve with a cartridge (112) disposed therein; and
(b) a linear spring-biased slide hammer (120) comprising a linear shaft (130) having a shaft first end (131) and a shaft second end (132), wherein a gripping handle (140) is disposed on the shaft second end (132), wherein a stop (135) is disposed on the shaft first end (131), wherein the linear shaft (130) comprises a channel (152) disposed between the gripping handle (140) and the stop (135), wherein a slide weight (150) is slidably disposed on the linear shaft (130) through the channel (152), wherein a spring (160) is disposed on the shaft (130) between the gripping handle (140) and the slide weight (150), wherein the slide weight (150) is biased in a static position at the shaft first end (131) against, the stop (136), wherein a threaded adapter (170) is disposed on the shaft first end (131) adjacent to the stop (135):
wherein the slide hammer (120) is rotatably screwed into a threaded aperture (113) of the cartridge (112) via the mated threaded adapter (170) until snug, wherein the slide weight (150) is pulled away from the stop (135) toward the shaft second end (132), then released to create an impact upon colliding with the stop (135) via the loaded spring (160), wherein the impact is transferred to the cartridge (112) for freeing seized parts in the cartridge (112) via the threaded adapter (170) interfacably connecting to the threaded aperture (113).

2. The system (100) of claim 1, wherein the water tap is mixing water tap.

3. The system (100) of claim 1, wherein the slide weight (150) weighs 14 ounces.

4. The system (100) of claim 1, wherein the slide weight (150) weighs 4-8 ounces.

5. The system (100) of claim 1, wherein the slide weight (150) weighs 8-16 ounces.

6. The system (100) of claim 1, wherein the slide weight (150) weighs 16 or more ounces.

7. A linear spring-biased slide hammer (120) for use in a cartridge maintenance system (100), the linear spring-biased slide hammer comprising:
(a) a linear shaft (130) having a shaft first end (131) and a shaft second end (132);
(b) a gripping handle (140) disposed on the shaft second end (132);
(c) a stop (136) disposed on the shaft first end (131);
(d) a channel (152) disposed between the gripping handle (140) and the stop (135);
(e) a slide weight (150) slidably disposed on the linear shaft (130) through the channel (152), wherein the slide weight (150) is biased in a static position at the shaft first end (131) against the stop (135);
(f) a spring (160) disposed on the shaft (130) between the gripping handle (140) and the slide weight (160); and
(g) a threaded adapter (170) disposed on the shaft first end (131) adjacent to the stop (135);
wherein the slide hammer (120) is configured to be rotatably screwed into a threaded aperture (113) of a cartridge (112) of a valve of a water tap via the mated threaded adapter (170) until snug;
wherein the slide weight (150) is pulled away from the stop (135) toward the shaft second end (132), then released to create an impact upon colliding with the stop (135) via the loaded spring (160);
wherein the linear spring-biased slide hammer (120) is configured to transfer the impact to the cartridge (112) for freeing seized parts in the cartridge (112) via the threaded adapter (170) interfacably connecting to the threaded aperture (113).

8. The linear spring-biased slide hammer (120) of claim 7, wherein the ide weight (150) weighs 14 ounces.

9. The linear spring-biased slide hammer (120) of claim 7, wherein the slide weight (150) weighs 4-8 ounces.

10. The linear spring-biased slide hammer (120) of claim 7, wherein the slide weight (150) weighs 8-16 ounces.

11. The linear spring-biased slide hammer (120) of claim 7, wherein the slide weight (150) weighs 16 or more ounces.

12. A method for freeing a seized cartridge in a tap, the method comprising:
(a) providing a linear spring-biased slide hammer (120) comprising:
i. a linear shaft (130) having a shaft first end (131) and a shaft second end (132),
ii. a gripping handle (140) disposed on the shaft second end (132),
iii. a stop (135) disposed on the shaft first end (131),
iv. a channel (152) disposed between the gripping handle (140) and the stop (135),
v. a slide weight (150) slidably disposed on the linear shaft (130) through the channel (152), wherein the slide weight (150) is biased in a static position at the shaft first end (131) against the stop (135),
vi. a spring (160) disposed on the shaft (130) between the gripping handle (140) and the slide weight (150), and
vii. a threaded adapter (170) disposed on the shaft first end (131) adjacent to the stop (135);
(b) rotatably screwing the slide hammer (120) into a threaded aperture (113) of a cartridge (112) of a valve of a water tap via the mated threaded adapter (170) until snug;
(c) pulling the slide weight (150) away from the stop (135) toward the shaft second end (132); and
(d) releasing the slide weight (150) to create an impact upon colliding with the stop (135) via the loaded spring (160);
wherein the linear spring-biased slide hammer (120) transfers the impact to the cartridge (112) to free seized parts in the cartridge (112) via the threaded adapter (170) interfacably connecting to the threaded aperture (113).

13. The method of claim 12, wherein, the water tap is a mixing water tap.

14. The method of claim 12, wherein the slide weight (150) weighs 1-4 ounces.

15. The method of claim 12, wherein the slide weight (150) weighs 4-8 ounces.

16. The method of claim 12, wherein the slide weight (150) weighs 8-16 ounces.

17. The method of claim 12, wherein the slide weight (150) weighs 16 or more ounces.
